(19) United States
(12) Patent Application Publication
(10) Pub. No.: US 2016/0041361 A1
(43) Pub. Date: Feb. 11, 2016

(54) MOUNTING APPARATUS

(71) Applicant: Sandia Corporation, Albuquerque, NM (US)

(72) Inventor: Aaron M. Ison, Albuquerque, NM (US)

(21) Appl. No.: 14/694,085

(22) Filed: Apr. 23, 2015

Related U.S. Application Data
(60) Provisional application No. 62/033,896, filed on Aug. 6, 2014.

(51) Int. Cl. G02B 7/00; F16B 2/22; F16M 13/02

(52) U.S. Cl. CPC G02B 7/008; F16M 13/02; F16B 2/22

(57) ABSTRACT

Apparatuses for mounting an element are disclosed herein. In a general embodiment, the apparatus includes a mounting apparatus having a plurality of flexure arms positioned around an outer periphery of the mounting apparatus. The arms are for contacting an element when an element is positioned in the mounting apparatus. The apparatus also includes couplers configured for coupling the flexure arms together. The flexure arms apply a radial compressive force to an element when an element is installed in the mounting apparatus.

### RELATED APPLICATION

This application claims priority to U.S. Provisional Patent Application No. 62033,896, filed on Aug. 6, 2014, and entitled “MOUNTING APPARATUS”, the entirety of which is incorporated by reference.

### STATEMENT OF GOVERNMENTAL INTEREST

This invention was developed under Contract DE-AC04-94AL85000 between Sandia Corporation and the U.S. Department of Energy. The U.S. Government has certain rights in this invention.

### BACKGROUND

A conventional mounting apparatus, such as an optics mounting apparatus, includes compression wave springs, mounting arms, ledges, or other similar structures that are configured to hold an element, such as a lens or mirror, in the center of the mounting apparatus. Mounting apparatus are often subjected to environments with varying temperatures. Variations in temperatures can cause the mounting apparatus and element to expand or shrink. Because the mounting apparatus and element are made of different materials, they expand and shrink at different rates. Mounting apparatus are designed to take these changes into account in order to maintain the element in the center of the mounting apparatus within allowable tolerances. A conventional mounting apparatus, however, tends to lose center alignment of the element under varying temperatures. Further, a design of a conventional mounting apparatus is typically only well-suited for a small set of mounting optical elements. Existing designs are not readily extendible. If it is desirable to mount other, different optical elements, an entirely new design is typically needed in order to accommodate the different optical element.

For example, a mounting apparatus for an optical system is conventionally designed to be capable of housing optical materials that encounter a limited set of thermal variations. Furthermore, conventional apparatuses may not take into account differences in coefficients of thermal expansion between the element and the mounting apparatus. Because such systems do not accommodate for differences in coefficient of thermal expansion between the mounting apparatus and the element, they lose their ability to properly center the element in the mounting apparatus.

### SUMMARY

Mounting apparatuses are disclosed herein. In a general embodiment, the mounting apparatus includes a plurality of flexure arms. The flexure arms apply a radial force that is geometrically designed to apply a compression load to an element. In an example, the flexure arms contact the element at three spaced locations that are 120 degrees apart. As the element and the mounting apparatus experiences a change in thermal environment, the flexure arms grow or shrink at a different rate than the element. As the arms and the element change in size, the plurality of flexure arms apply a radial force to the element in order to force the element to the geometric center of the mounting apparatus. Specifically, the system is designed so that the materials of the various parts and their respect thermal characteristics are taken into account when designing the shape and size of the arms so that the mounting apparatus expands more slowly than the element.

The mounting apparatus itself is intended to mount to a host superstructure. The element is mounted inside the mounting apparatus, thus making the mounting apparatus a subcell to the host superstructure. As the thermal environment changes, the element and the mounting apparatus material grow at different rates, specifically the mounting apparatus expands at a slower rate than the element. The element experiences the bending of the flexure arms as a sliding motion at the radial point of contact on the element surface. The geometric symmetry of the flexure arms ensures each contact point applies the same amount of radial load, thus forcing the element to remain at the geometric center of the mounting apparatus.

Additional features and advantages are described herein, and will be apparent from the following Detailed Description and the figures.

### BRIEF DESCRIPTION OF THE DRAWINGS

FIG. 1 is a perspective view of an exemplary mounting apparatus;

FIG. 2 is a perspective view of the mounting apparatus of FIG. 1 with an optical element mounted to the mounting apparatus;

FIG. 3 is a top view of the mounting apparatus and element of FIG. 2, showing how radial forces are applied to the element to maintain the element in position on the mounting apparatus regardless of temperature fluctuations;

FIG. 4 is a bottom view of the mounting apparatus and element of FIG. 2; and

FIG. 5 is a flow diagram illustrating an exemplary methodology for operating a mounting apparatus.

### DETAILED DESCRIPTION

Mounting apparatuses are disclosed herein. In a general embodiment, the mounting apparatus is designed to house fragile optical materials in systems that experience large thermal variations. The mounting apparatus accommodates any difference between the coefficient of thermal expansion of the mounting apparatus and the optical material of the element while controlling centering of the optic within the system. The system permits better centration control and tolerance of the optical systems, which experience thermal environments, such as those that exist in space and in cryogenic environments. The system utilizes flexures that radially contact an optic installed in the mounting apparatus. The flexures apply a radial compressive force, which can be tailored to any load necessary.

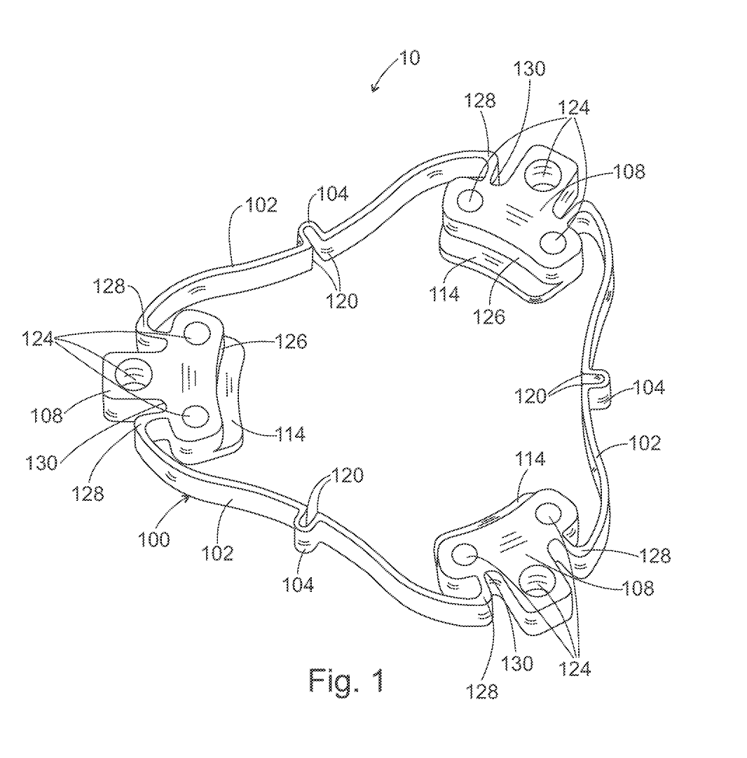

In an embodiment shown in FIGS. 1-3, the mounting apparatus includes three locations for contacting an element installed in the mounting apparatus. The three locations are 120 degrees apart. The shape and profile of the flexures is fully customizable to create any compressive force necessary to hold the optic element. The profile of the compressive members is 2D, which allows the entire design to be easily and inexpensively manufactured through common practices. As the mounting apparatus experiences thermal changes, a difference in growth/shrinkage between the optic and the mounting apparatus occurs. As this thermal growth occurs, the flexures force the optic to the geometric center of the mounting apparatus. This allows the optic to appear as though it is floating in space though all temperatures. This reduces the centration error that commonly occurred with some prior art devices, greatly increasing performance consistency.

The exemplary apparatus described herein provides tight positional control of components through thermal environments. The design also accommodates shock and vibration environments by helping to dampen the input to the element being held by the mounting apparatus. The design may be useful for telescopes, interferometers, laser systems, and the like, among other known environments. The mounting apparatus may be manufactured with existing manufacturing processes and may be tuned to the desired mounting and restraint force.

The mounting apparatus itself is intended to mount to a host structure, while the optic is mounted internally. Thus, the mounting apparatus is a subcell of a larger superstructure. The specific size and shape of the flexures are entirely customizable to any given design need. Each flexure blade is geometrically dimensioned and fabricated to be identical, within mechanical tolerances. The flexure is designed to apply a compression load to the element installed in the mounting apparatus through the required environmental range. The geometric symmetry of the flexures ensures each contact point applies the same amount of radial load, which results in a centering of the element in the mounting apparatus. An axial load is also applied to the element when installed in the mounting apparatus. The axial load is provided by an axial load plate that extends over the element and applies an appropriate axial load to the element in order to ensure the position of the element during thermal changes. The flexures of the mounting apparatus and the axial load members work together in concert to maintain the position of the optic element through mechanical and thermal environments.

With reference to FIG. 1, an exemplary mounting apparatus is depicted. The mounting apparatus 100 includes three (3) flexure arms 102 that are coupled together by connector members 107 at the ends of each of the arms. Three (3) connector members are shown in FIG. 1. Each of the connector members includes an inwardly extending ledge. The ledge extends inwardly near a bottom surface of the connector members. The ledge is provided to trap an optical element axially within the opening of the mounting apparatus.

Each connector member includes bolt holes. The bolt holes may be used for coupling the mounting apparatus to a superstructure, such as an airplane fuselage. In addition, the bolt holes may be used for coupling another plate member to the mounting apparatus.

The mounting apparatus shown in FIG. 1 is substantially triangular, with each of the arms forming a side of the triangle. The term “substantially,” as used herein, is a term of estimation. The center of the mounting apparatus is open and is for receiving the element, such as an optical element. The element, when installed seats on the ledges of each connector member, and an outer periphery of the element is contacted by each of the arms. In general, an element does not contact the wall adjacent each of the ledges, although the element may contact the wall adjacent each ledge in some circumstances.

Each flexure arm 102 has an inwardly bending configuration and is configured to bend inwardly. In addition, each arm includes a radially outwardly extending nose 104. The noses 104 are positioned centrally on each of the arms and are configured to assert a radial compressive force 103 inwardly towards a center point in the mounting apparatus 100. When an element is installed in the mounting apparatus, each arm will exert a radially inward force on the element in order to retain the element in the mounting apparatus. The radially inward force that is exerted by each arm positions the element 106 at the geometric center of the mounting apparatus 100. The flexure noses 104 maintain the radial position of the element 106. The flexure arms 102 are customized for each application and apply a radially inward force to the element in order to retain the element in the mounting apparatus. In addition, the respective plurality of flexure noses and arms 104, 102 are sized to remain within an elastic region of the material that they are made of.

The material selection of the flexure arms 102 is such that a flexure arms 102 coefficient of thermal expansion is less than the coefficient of thermal expansion of the element 106. For example, responsive to an expansion of the element 106, the flexure nose 102 contracts and extends along a line away from the center point, wherein the distance between the respective radial compressive forces 103 lessens. As another example, responsive to a contraction of the element 106, the flexure nose 104 expands and extends along a line towards the center point. As the element 106 grows outwards, the flexure arm 102 bends outwards, the radial compressive forces 103 slide, thereby forcing the springs outward and creating a pinch point.

The nose 104 shown is substantially U-shaped, with the top end of the U-shape providing the contact points for the element when installed in the mounting apparatus. Thus, two contact points are provided at each nose, with a total of six contact points being provided in the exemplary embodiment shown. As the optical element grows in size, it will press on the contact points of the arms, forcing the nose outwardly and the contact points closer together. As the optical element shrinks, the arms will move inwardly and the contact points will move farther apart. The arms and nose are designed so that the element is always under a compressive force. The contact points create a flat line of contact with the element at each nose.

The arms also include an inwardly bending portion at each end of the arms, such that the arms are nearly perpendicular to themselves at their ends, relative to the majority of the length. The ends of the arms couple to an outer surface of the connector members, behind the ledges. Other designs for the shape and size of the arms may be used, as long as the required compressive forces are applied throughout the entire range of thermal characteristics of the design environment.

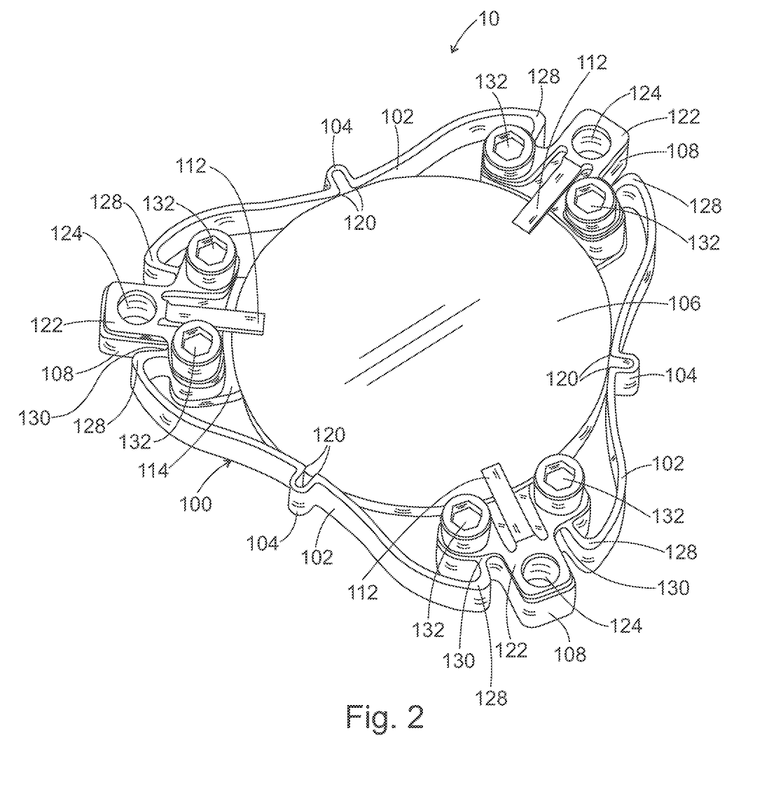

Referring to FIGS. 2-4, an element, such as an optical element, is shown installed in the mounting member. In addition, an axial plate member is coupled to an upper surface of the connector members via bolts that extend through several of the bolt holes of the connector members. The axial plate member had bolt holes that align with the bolt holes of the connector members. The axial plate member may also include a bolt hole that aligns with a hole of the connector member that is utilized for coupling the mounting apparatus to a superstructure. The axial plate member includes a spring member 112, the spring member 112 is positioned over the ledge of the mounting apparatus and may be centrally located between the bolt holes, if desired. The spring member 112 may be tab-shaped and is configured to apply an axial force downwards toward an element installed in the mounting apparatus. The ledge 114 is configured to absorb a shock applied to the mounting apparatus 100. The spring tab 112 is positioned over an element and the ledge 114 defines a bottom position of the element 106. The spring tab 112 and ledge 114 may be optional elements.

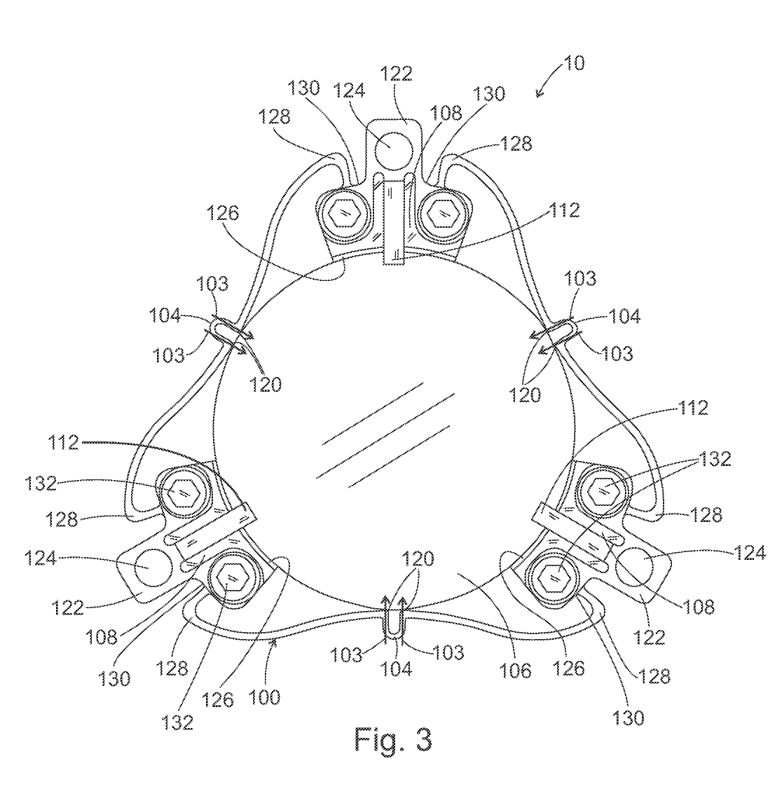

FIG. 3 depicts the forces that are applied inwardly by the contact points 120 of the nose 104. As is evident, the forces applied are directed towards the center of the element 106. Because the arms 102 are substantially the same size and shape, they apply equal forces to the periphery of the element 106. This allows for the element 106 to be continually centrally located in the mounting apparatus 100.

As for exemplary sizes of the mounting apparatus 100, in an example, the diameter of the mounting apparatus 100 is between 1.5 inches and 40 inches. As for exemplary sizes of the flexure arms 102, in an example, the flexure arms 102 are between 0.05 inches and 0.25 inches thick. The arms may be other thicknesses and lengths.

In an example where the element 106 has a 40 inch diameter, the mounting apparatus 100 may comprise up to twenty flexure arms 102, in order to provide a plurality of radial compressive forces 103 to maintain the element 106 in the geometric center of the mounting apparatus 100. In another example where the element 106 has a 40 inch diameter, the mounting apparatus may comprise three flexure arms 102, and the flexure arms 102 would be sized to provide a plurality of radial compressive forces 103 to maintain the element 106 in the geometric center of the mounting apparatus 100. When three arms are used, the noses of each arm are spaced 120 degrees apart.

Any number of arms may be used and the number of arms is a function of the size of the element. When it is desired that the mounting apparatus take us as little space as possible, more arms may be used. If size is not a concern, fewer arms may be used. The mass of the element helps to dictate the size of the arms. The thickness and height may be tailored to each element. Depending upon the type of material to be utilized, the arms are designed in view of the particular spring stiffness of the material.

In an embodiment, the flexure nose 104 remains within an elastic regime of the mounting apparatus 100 at a minimum of one degree Kelvin. The flexure nose 104 and arms are designed in view of the minimum temperature anticipated by the environment in which the mounting apparatus will be situated.

The nose shown in the figures is substantially U-shaped. Other shapes may alternatively be used, such as circular or oval, among other shapes. Alternative elements to the ledge and axial spring could be used. A smaller ledge, for example, could be used. Any type of axial spring that pushes the element towards the ledge can be utilized.

An element that is different from the axial plate member may be used. Any type of device that assists in maintaining the axial position of the element in the mounting apparatus may be used.

Optic element other than round elements may be used with the mounting apparatus. For example, square, rectangular, oval, irregular, or other shaped elements may be used. The arms and connector member shall be designed around the element in order to continually apply a radial force to the element.

The arms may alternatively be referred to as bands that buckle inwardly toward the center of the mounting apparatus. The bands are designed to apply an amount of force to the element. The bands can be varied in size by altering the height and/or thickness of the bands. Alternatively, the bands could be tapered or varied in thickness along their length or height, if desired.

Any number of arms may be utilized, depending on the size and weight of the element. For example, 3 or more arms may be used, such as 4 or 5, 6, 9, 12, 14, 16, 20, 25, 30, 40, or any increments therebetween. The design described herein permits easy scaling of the mounting apparatus for any size element.

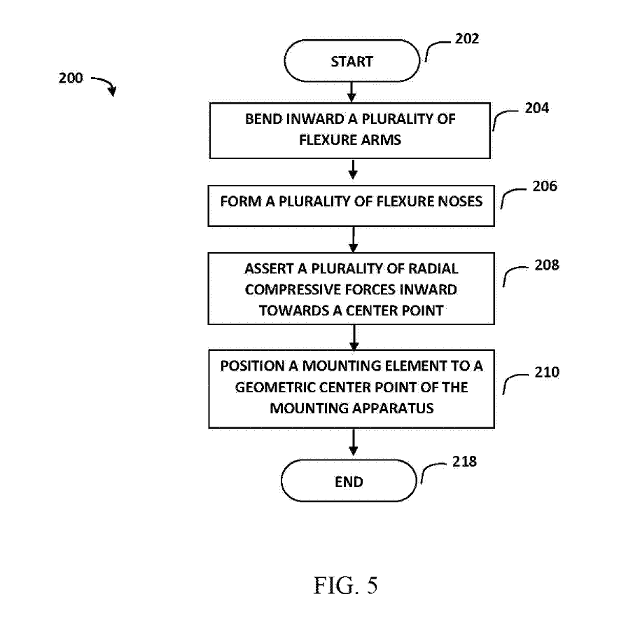

FIG. 5 is a flow diagram illustrating an exemplary methodology for operating a mounting apparatus 100. The methodology 200 starts at 202. At 204, a plurality of flexure arms 102 are bent inward, thereby at 206 forming a plurality of flexure noses 104. For example, responsive to an expansion of the element 106, the flexure nose 104 contracts. In another example, responsive to contraction of the element 106, the flexure nose 104 expands.

At 208, the contact points 120 of the plurality of flexure noses 104 assert a plurality of radial compressive forces 103 inward towards a center point of the mounting apparatus 100. For example, responsive to the flexure nose 104 contracting, the respective radial compressive forces 103 are positioned closer to each other, at a rate less than a rate of expansion of the element 106. In another example, responsive to the flexure nose 104 expanding, the respective radial compressive forces 103 are positioned further apart from each other, at a rate less than a rate of contraction of the element 106.

At 210, the flexure noses 104 position the element 106 to the center point of the mounting apparatus 100. In an example, responsive to the respective radial compressive forces 103 positioned closer to each other, the flexure nose 104 is extended along a line away from the center point. In another example, responsive to the respective radial compressive forces 103 positioned further from each other, the flexure nose 104 is extended along a line towards the center point. The methodology 200 completes at 212.

The mounting apparatus may be made of a metal, plastic, glass, combinations thereof, or other material. Titanium is a type of metal that may be utilized in conditions that have wide temperature swings because Titanium has a low coefficient of thermal expansion. Another suitable material for conditions with wide temperature swings is Beryllium Copper. Aluminum may also be used in some conditions, among other materials.

The mounting apparatus and various parts are shown as having an upper surface that is substantially flat. If desired, the surfaces could have other shapes, such as curved or beveled, if desired.

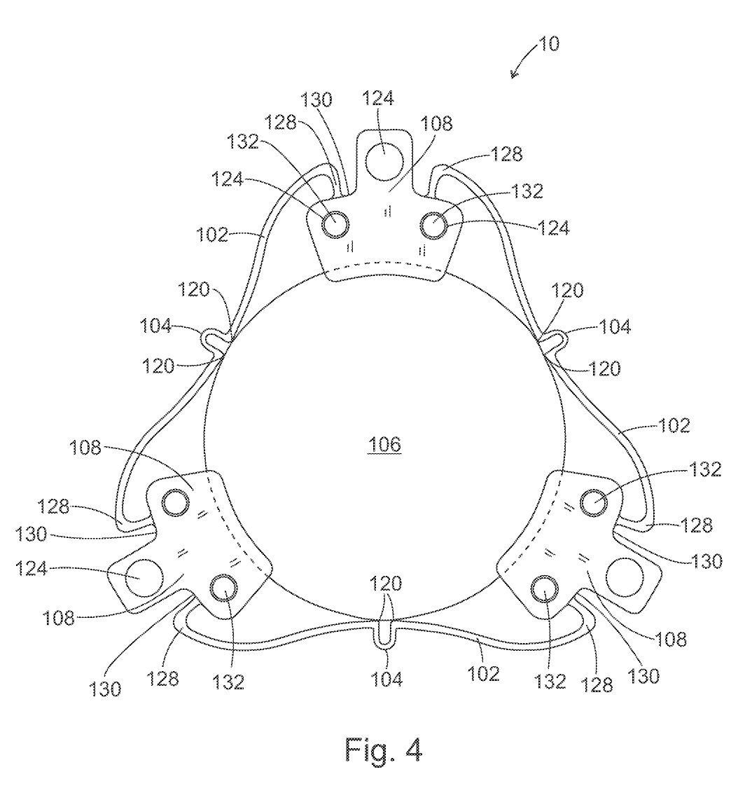

FIG. 4 depicts a bottom surface of the mounting apparatus 100 with an element 106 installed in the mounting apparatus 100. The contact points 120 of the flexure arms 102 engage the periphery of the element 106 at locations that are space 120 degrees apart. The connector members 108 are shown coupled to the ends 128 of the arms 102. The connector members 108 have a height that is greater than the height of the arms 102, although the height of the arms may alternatively be the same height as the connector members 108 or a greater height, if desired. While the bottom surface of the connector members 108 and arms are shown as being flat, they could be contoured, beveled, or otherwise shaped, depending upon the application. For example, if the superstructure has a non-flat surface, the connector members may have a mating shape for joining with the non-flat surface of the superstructure. While two bolt holes 124 are shown for coupling the axial plate member to the connector member 108, more or less than two bolt holes could be used. In addition, while a single bolt hole 124 is shown for the purpose of coupling to the superstructure, more holes could be provided, if desired. In addition, the shape of the connector member can be changed to any desired shape as long as the ledge, or a structure providing a similar function, is provided.

In one embodiment, an apparatus for mounting an element includes a mounting apparatus having a plurality of flexure arms and couplers configured for coupling the flexure arms together. The arms are positioned around an outer periphery of the mounting apparatus for contacting an element when an element is positioned in the mounting apparatus. The flexure arms apply a radial compressive force to an element when an element is installed in the mounting apparatus in order to retain an element in the mounting apparatus.

The apparatus may also include a securing mechanism configured for axially securing an element in the mounting apparatus.

Each flexure arm may include an outwardly extending nose, with the nose having at least two contact points for contacting a periphery of an element when an element is installed in the mounting apparatus. The nose may have two legs and may be substantially U-shaped, with the contact points of the nose being at the top end of each leg of the U-shape. The flexure arms may include an inwardly directed bend. The nose may be positioned substantially at a center of the inwardly directed bend of each arm. The contact points of each nose are the points of contact for exerting the radial compressive force, with the radial compressive force extending inwardly towards an element when an element is installed in the mounting apparatus. The radial compressive force may assist in centering an element in the mounting apparatus. The flexure arms may be made of a material and sized such that the noses remain within an elastic region of the respective material of the flexure arms.

The couplers configured for coupling the flexure arms together may be connector members. The securing mechanism configured for axially securing an element in the mounting apparatus may be axial force plates, with the connector members including coupling points for permitting coupling of the axial force plate to the connector members. The securing mechanism configured for axially securing an element in the mounting apparatus may include an inner ledge positioned on the connector members for receiving a part of an element when an element is installed in the mounting apparatus.

The axial force plates may include an inwardly extending member that is positioned over the ledges of the connector members for retaining an element in the mounting apparatus in an axial direction. The flexure arms may have a coefficient of thermal expansion that is lower than a coefficient of thermal expansion of an element that seats in the mounting apparatus. Responsive an expansion of an element installed in the mounting apparatus, the flexure noses contract such that the legs of the U-shape become closer together. Responsive to a contraction of an element installed in the mounting apparatus, the flexure noses expand such that the legs of the U-shape become farther apart.

The mounting apparatus may be made of any suitable material including, for example, a metal material, a plastic material, a glass material, or a combination thereof.

The plurality of flexure arms may include three flexure arms and the noses are positioned 120 degrees apart. The plurality of flexure arms includes three or more flexure arms.

The inwardly extending members of the axial force plates may be spring tabs that are configured to apply an axial force towards a center point of the mounting apparatus. The ledges may be configured to absorb a shock applied to the mounting apparatus. The ledges may include a shock absorbing member that is positioned between an element and the ledge for absorbing a shock applied to the mounting apparatus.

The coupling points of the connector members are bolt holes and the axial force plates further comprise bolt holes that are axially aligned with the bolt holes of the connector members. The bolt holes are configured to join the axial force plate to the connector member with the use of bolts, and to join the connector members to a superstructure.

In another embodiment, an apparatus for holding an element in an environment with a range of thermal characteristics includes a plurality of arms and a plurality of connectors configured for coupling the arms together. The plurality of arms includes an outwardly extending nose positioned at a central location on each arm. The nose of each arm exerts an inwardly extending compressive force toward a center point of the apparatus. The plurality of connectors is for coupling the arms together and for coupling the apparatus to a superstructure. The connectors include a connecting mechanism for contacting an element. The arms are made of an elastic material and are sized so that the arms are always within an elastic region of the material in the range of thermal characteristics. The arms are sized to maintain an element installed between the plurality of arms such that a center point of the element aligns with a center point of the apparatus.

As used herein, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form. Additionally, as used herein, the term “exemplary” is intended to mean serving as an illustration or example of something, and is not intended to indicate a preference, and the term “about” refers to a range of 10% of the value to which the term applies.

All patents, patent applications, publications, technical and/or scholarly articles, and other references cited or referred to herein are in their entirety incorporated herein by reference to the extent allowed by law. The discussion of those references is intended merely to summarize the assertions made therein. No admission is made that any such patents, patent applications, publications or references, or any portion thereof, are relevant, material, or prior art. The right to challenge the accuracy and pertinence of any assertion of such patents, patent applications, publications, and other references as relevant, material, or prior art is specifically reserved.

In the description above, for the purposes of explanation, numerous specific details have been set forth in order to provide a thorough understanding of the embodiments. It will be apparent however, to one skilled in the art, that one or more other embodiments may be practiced without some of these specific details. The particular embodiments described are not provided to limit the invention but to illustrate it. The scope of the invention is not to be determined by the specific examples provided above but only by the claims below. In other instances, well-known structures, devices, and operations have been shown in block diagram form or without detail in order to avoid obscuring the understanding of the description. Where considered appropriate, reference numerals or terminal portions of reference numerals have been repeated among the figures to indicate corresponding or analogous elements, which may optionally have similar characteristics.

What has been described above includes examples of one or more embodiments. It is, of course, not possible to describe every conceivable modification and alteration of the above devices or methodologies for purposes of describing the aforementioned aspects, but one of ordinary skill in the art can recognize that many further modifications and permutations of various aspects are possible. Accordingly, the described aspects are intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

It should also be appreciated that reference throughout this specification to “one embodiment”, “an embodiment”, “one or more embodiments”, or “different embodiments”, for example, means that a particular feature may be included in the practice of the invention. Similarly, it should be appreciated that in the description various features are sometimes grouped together in a single embodiment, figure, or description thereof for the purpose of streamlining the disclosure and aiding in the understanding of various inventive aspects. This method of disclosure, however, is not to be interpreted as reflecting an intention that the invention requires more features than are expressly recited in each claim. Rather, as the following claims reflect, inventive aspects may lie in less than all features of a single disclosed embodiment. Thus, the claims following the Detailed Description are hereby expressly incorporated into this Detailed Description, with each claim standing on its own as a separate embodiment of the invention.

What is claimed is:

1. An apparatus for mounting an element comprising:
a mounting apparatus having a plurality of flexure arms positioned around an outer periphery of the mounting apparatus for contacting an element when an element is positioned in the mounting apparatus and couplers configured for coupling the flexure arms together, wherein the flexure arms apply a radial compressive force to an element when an element is installed in the mounting apparatus in order to retain an element in the mounting apparatus.

2. The apparatus of claim 1, further comprising a securing mechanism configured for axially securing an element in the mounting apparatus.

3. The apparatus of claim 1, wherein each flexure arm includes an outwardly extending nose, with the nose having at least two contact points for contacting a periphery of an element when an element is installed in the mounting apparatus.

4. The apparatus of claim 3, wherein the nose has two legs and is substantially U-shaped, and the contact points of the nose are at the top end of each leg of the U-shape.

5. The apparatus of claim 3, wherein the flexure arms include an inwardly directed bend, and the nose is positioned substantially at a center of the inwardly directed bend of each arm.

6. The apparatus of claim 3, wherein the contact points of each nose are the points of contact for exerting the radial compressive force, with the radial compressive force extending inwardly towards an element when an element is installed in the mounting apparatus.

7. The apparatus of claim 6, wherein the radial compressive force assists in centering an element in the mounting apparatus.

8. The apparatus of claim 3, wherein the flexure arms are made of a material and sized such that the noses remain within an elastic region of the respective material of the flexure arms.

9. The apparatus of claim 2, wherein the couplers configured for coupling the flexure arms together are connector members and the securing mechanism configured for axially securing an element in the mounting apparatus are axial force plates, with the connector members including coupling points for permitting coupling of the axial force plate to the connector members.

10. The apparatus of claim 9, wherein the securing mechanism configured for axially securing an element in the mounting apparatus includes an inner ledge positioned on the connector members for receiving a part of an element when an element is installed in the mounting apparatus.

11. The apparatus of claim 10, wherein the axial force plates include an inwardly extending member that is positioned over the ledges of the connector members for retaining an element in the mounting apparatus in an axial direction.

12. The apparatus of claim 1, wherein the flexure arms have a coefficient of thermal expansion that is lower than a coefficient of thermal expansion of an element that seats in the mounting apparatus.

13. The apparatus of claim 3, wherein responsive to an expansion of an element installed in the mounting apparatus, the flexure noses contract such that the legs of the U-shape become closer together; and
wherein responsive to a contraction of an element installed in the mounting apparatus, the flexure noses expand such that the legs of the U-shape become farther apart.

14. The apparatus of claim 1, wherein the mounting apparatus is made of a metal material, a plastic material, a glass material, or a combination thereof.

15. The apparatus of claim 3, wherein the plurality of flexure arms include three flexure arms and the noses are positioned 120 degrees apart.

16. The apparatus of claim 1, wherein the plurality of flexure arms include three or more flexure arms.

17. The apparatus of claim 11, wherein the inwardly extending members of the axial force plates are spring tabs that are configured to apply an axial force towards a center point of the mounting apparatus.

18. The apparatus of claim 10, wherein the ledges are configured to absorb a shock applied to the mounting apparatus; or the ledges include a shock absorbing member that is positioned between an element and the ledge for absorbing a shock applied to the mounting apparatus.

19. The apparatus of claim 9, wherein the coupling points of the connector members are bolt holes and the axial force plates further comprise bolt holes that are axially aligned with the bolt holes of the connector members, with the bolt holes configured to join the axial force plate to the connector member with the use of bolts, and to join the connector members to a superstructure.

20. An apparatus for holding an element in an environment with a range of thermal characteristics comprising:
a plurality of arms that include an outwardly extending nose positioned at a central location on each arm, wherein the nose of each arm exerts an inwardly extending compressive force toward a center point of the apparatus; and
a plurality of connectors configured for coupling the arms together and for coupling the apparatus to a superstructure, said connectors including a connecting mechanism for contacting an element,
wherein the arms are made of an elastic material and are sized so that the arms are always within an elastic region of the material in the range of thermal characteristics, and the arms are sized to maintain an element installed between the plurality of arms such that a center point of the element aligns with a center point of the apparatus.
